(19) United States
(12) Patent Application Publication
(10) Pub. No.: US 2022/0198934 A1
(43) Pub. Date: Jun. 23, 2022

(54) VEHICLE-PLATOONING DRIVING DECISION SYSTEM AND METHOD THEREOF

(71) Applicant: AUTOMOTIVE RESEARCH & TESTING CENTER, Changhua Hsien (TW)

(72) Inventor: Wei-Hsuan Chang, Changhua Hsien (TW)

(21) Appl. No.: 17/132,273

(22) Filed: Dec. 23, 2020

(51) Int. Cl. G08G 1/00; G05D 1/02; H04W 4/46

(52) U.S. Cl. CPC G08G 1/22; G05D 1/0295; G05D 2201/0213; H04W 4/46; G05D 1/0293

(57) ABSTRACT

A driving decision system for a car platoon and a method thereof, applied to a car platoon, including a follower-car controlling device and a front-car controlling device, when the follower-car controlling device detects a cut-in event, outputs a follower-car deceleration command to control the follower car to decelerate, and transmits a cut-in notification and a follower-car deceleration notification; when the follower-car controlling device builds a connection with the front-car controlling device, the front-car controlling device receives the cut-in notification and the follower-car deceleration notification and outputs a front-car acceleration command to control the front car to accelerate, and transmits a front-car acceleration notification to the follower-car controlling device; when the cut-in event has been excluded, the follower car is to accelerate and the front car is to decelerate.

### BACKGROUND OF THE INVENTION

### 1. Field of the Invention

The present invention relates to an automatic driving decision system and a method thereof, particularly to a vehicle-platooning driving decision system and method thereof.

### 2. Description of the Related Art

Generally, a car platoon includes a plurality of cars, each of which has an automatic assisting driving function or an automatic driving function. Taking an example for a front car and a follower car, the follower car follows the front car according to a following condition. The following condition can be a comparison information of car-following speeds and car-following distances. That is, the faster the car-following speed is, the longer the car-following distance is.

Besides, the car platoon drives in one lane of the road; however, there are other cars driving in another lane of the road. Since an interval exists between the front car and the follower car, other cars in another lane may cut into or across the interval between the front car and the follower car from one lane to another lane for overtaking or getting across the follower car. By this way, the follower car will be close to other cars and the front car will be close to other cars, too. Therefore, other cars cannot maintain a safe distance with the front car and the follower car of the car platoon and the risk of the car accident will be risen.

### SUMMARY OF THE INVENTION

In view of this, the main purpose of the present invention is to provide a vehicle-platooning driving decision system and method thereof to tackle the problem for other cars cutting into an interval between a front car and a follower car from one lane to another lane.

The vehicle-platooning driving decision system of the present invention is applied on a car platoon, which includes a follower car and a front car. The driving decision system for a car platoon includes:

a follower-car controlling device, disposed in the follower car to control the follower car to follow the front car, outputting a follower-car deceleration command to the follower car to control the follower car to decelerate, and wirelessly transmitting a cut-in notification and a follower-car deceleration notification when the follower-car controlling device detects a cut-in event;

a front-car controlling device, disposed in the front car, receiving the cut-in notification and the follower-car deceleration notification transmitted by the follower-car controlling device, outputting a front-car acceleration command to the front car to control the front car to accelerate according to the cut-in notification, and wirelessly transmitting a front-car acceleration notification to the follower-car controlling device when the follower-car controlling device builds a connection with the front-car controlling device;

when the follower-car controlling device detects that the cut-in event has been excluded, outputting a follower-car acceleration command to the follower car to control the follower car to accelerate, and wirelessly transmitting a cut-in-excluded notification and a follower-car acceleration notification to the front-car controlling device; the front-car controlling device outputting a front-car deceleration command to the front car to control the front car to decelerate according to the cut-in-excluded notification, and wirelessly transmitting a front-car deceleration notification to the follower-car controlling device.

The driving decision system for a car platoon of the present invention includes:

controlling a follower car to follow behind a front car according to a following condition via a follower-car controlling device;

the follower-car controlling device detecting whether a cut-in event is generated, if yes, the follower-car controlling device outputting a follower-car deceleration command to the follower car to control the follower car to decelerate, and wirelessly transmitting a cut-in notification and a follower-car deceleration notification;

wherein when the follower-car controlling device builds a connection with a front-car controlling device disposed in the front car, the front-car controlling device receives the cut-in notification and the follower-car deceleration notification, outputs a front-car acceleration command to the front car to control the front car to accelerate, and wirelessly transmits a front-car acceleration notification to the follower-car controlling device according to the cut-in notification;

wherein the follower-car controlling device detects whether the cut-in event has been excluded, if yes, the follower-car controlling device outputs a follower-car acceleration command to the follower car to control the follower car to accelerate, and wirelessly transmits a cut-in-excluded notification and a follower-car acceleration notice to the front-car controlling device;

wherein when the follower-car controlling device builds a connection with the front-car controlling device, the front-car controlling device outputs a front-car deceleration command to the front car to control the front car to decelerate, and wirelessly transmits a front-car deceleration notification to the follower-car controlling device according to the cut-in-excluded notification.

According to the driving decision system for a car platoon and a method thereof of the present invention, when the follower-car controlling device detects the cut-in event, which represents a car in another lane may cut into the interval between the front car and the follower car in the lane, the follower-car controlling device controls the follower car to decelerate according to the cut-in event. In addition, for the front car, according to the traffic situation of the road, for instance, when there are no cars in front of the front car, the front-car controlling device controls the front car to accelerate whereby the distance between the front car and the follower car can be increased so that the other cars can cut into the interval between the follower car and the front car to avoid the follower car hitting the other cars and the other cars hitting the front car. When the other cars drive away, the car platoon returns to the steady state of the car platoon by the deceleration of the front car and the acceleration of the follower car. In summary, the present invention can significantly solve the problem that the other cars cut into or across the interval between the front car and the follower car of the car platoon from one lane to another lane. The detailed embodiment of the present invention will be introduced below.

### BRIEF DESCRIPTION OF THE DRAWINGS

FIG. 1 is a schematic diagram of an embodiment of the present invention applied to the follower car and the front car of the car platoon;

FIG. 2 is a block diagram in the embodiment of the driving decision system of the present invention;

FIG. 3 is a block diagram for the follower-car controlling device connecting to each system of the follower car in the present invention;

FIG. 4 is a flow diagram for estimated a car interval distance in the present invention;

FIG. 5 is a flowchart of the embodiment of the driving decision system of the present invention;

FIG. 6A is a schematic diagram for another car cutting into the car platoon;

FIG. 6B is a schematic diagram for another car cutting into the car platoon;

FIG. 7A is a sequence diagram of information transmitted among the follower-car controlling device, the front-car controlling device, and the background host in the present invention (when the follower-car controlling device is connected to the front-car controlling device);

FIG. 7B is a sequence diagram of information transmitted among the follower-car controlling device, the front-car controlling device, and the background host in the present invention (when the follower-car controlling device is disconnected from the front-car controlling device);

FIG. 8 is a block diagram for the front-car controlling device connecting to each system of the front car in the present invention;

FIG. 9 is a schematic diagram for another car driving away from the car platoon;

FIG. 10 is a flow diagram for the follower-car controlling device to accelerate/decelerate according to an estimated car interval distance in the present invention;

FIG. 11 is a schematic diagram for the data format of the front-car information package in the present invention; and

FIG. 12 is a schematic diagram for an information synchronization mechanism of the follower-car controlling device, the front-car controlling device, and the background host in the present invention.

### DETAILED DESCRIPTION OF THE INVENTION

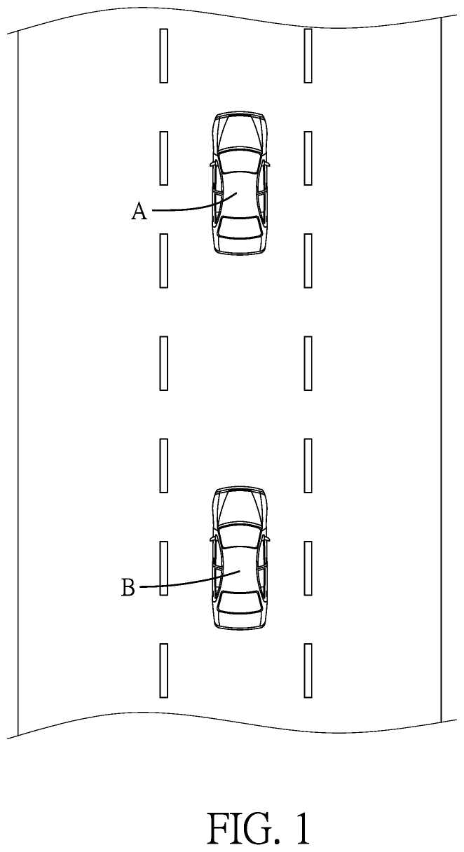

The vehicle-platooning driving decision system of the present invention is applied to a car platoon. Generally speaking, the car platoon includes a plurality of cars, each of which includes an automatic assisting driving function or an automatic driving function. Please refer to FIG. 1. The car platoon at least includes a front car A and a follower car B, wherein the front car A and the follower car B represent that the front car A is adjacent to the follower car B and the front car A is in front of the follower car in a lane, that is, the follower car B follows the front car A. The front car A can be, but not limited to, the first car of the car platoon, the follower car B can be, but not limited to, the last car of the car platoon. Moreover, the front car A and the follower car B are not limited to the hybrid electric vehicles, the electric vehicles, or the gasoline vehicles adopting a gasoline engine or a diesel engine.

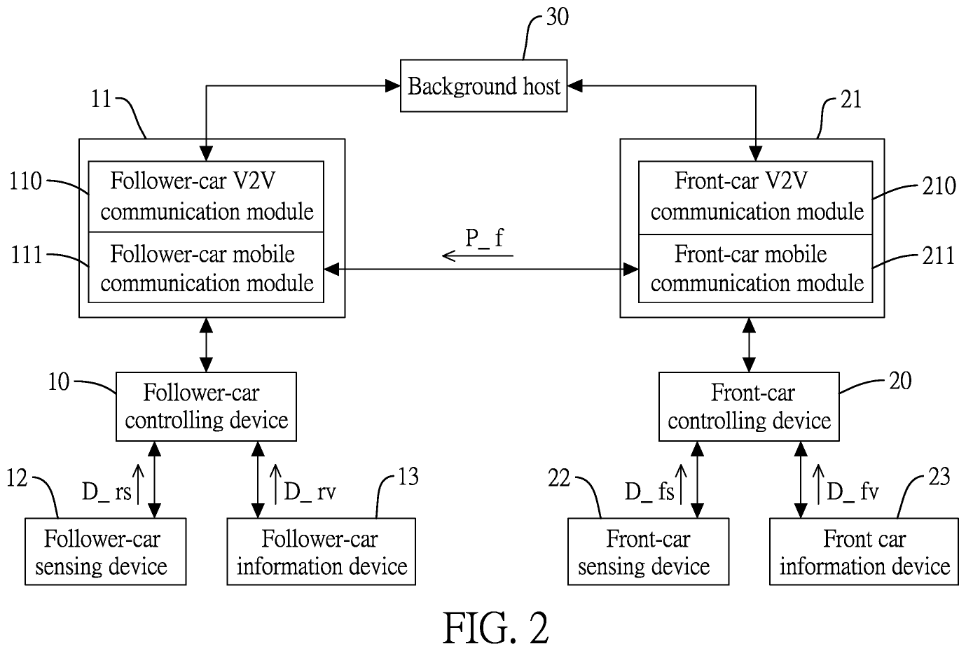

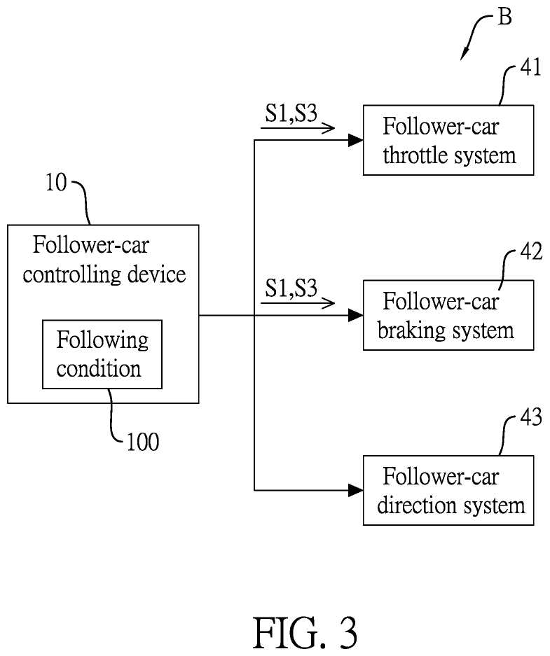

Please refer to FIG. 1, FIG. 2, and FIG. 3. The embodiment of the vehicle-platooning driving decision system of the present invention includes a follower-car controlling device 10 and a front-car controlling device 20, or further includes a background host 30. Regarding the basic principle of each car, the below descriptions take the follower car B for example, and the basic principle of the front car A may be deduced from the follower car B. Please refer to FIG. 1 and FIG. 3. Generally speaking, the follower car B may include a follower-car throttle system 41, a follower-car braking system 42, and a follower-car direction system 43. The follower-car throttle system 41 is utilized to control the follower car B to accelerate and decelerate. The follower-car braking system 42 is utilized to control the braking action of the follower car B. The follower-car direction system 43 is utilized to control a steering angle of the follower car B or to control the follower car B to move straightly. The follower-car throttle system 41, the follower-car braking system 42, and the follower-car direction system 43 coordinately operate to achieve the automatic assisting driving function or the automatic driving function of the follower car B. The follower-car controlling device 10 of the present invention is signally connected to the follower-car throttle system 41, the follower-car braking system 42, and the follower-car direction system 43 to operate coordinately so that the follower car B can drive under a steady state. Furthermore, the follower car B follows the front car A according to a following condition.

Connection architecture, obtaining of information, estimating of a car interval distance, a follower-car estimated coordinate, an cut-in decision manner and an information synchronism mechanism of the follower-car controlling device 10 and the front-car controlling device 20 (or further including the background host 30) are respectively described in detail below.

### 1. Connection Architecture and Obtaining Of Information

The follower-car controlling device 10 may be an electronic control unit (ECU) or a car computer, performing an information algorithm and a following-car decision/controlling function. The follower-car controlling device 10 is disposed in the follower car B and signally connected to a follower-car communication device 11, a follower-car sensing device 12, and a follower-car information device 13 disposed in the follower car B.

The follower-car communication device 11 includes a follower-car V2V (vehicle-to-vehicle) communication module 110 or further includes a follower-car mobile communication module 111. The follower-car V2V communication module 110 implements the communication between one car and another. The follower-car V2V communication module 110 can be, but not limited to, the dedicated short range communication module (DSRC) or may be operated on the fourth generation mobile communication technology (4G), the fifth generation mobile communication technology (5G), or the advanced next generation mobile communication technology. The follower-car mobile communication module 111 implements the communication between the car and the other devices (Vehicle-to-everything, V2X). The follower-car mobile communication module 111 may be operated on the fourth generation mobile communication technology(4G), the fifth generation mobile communication technology(5G), or the advanced next generation mobile communication technology. The follower-car sensing device 12 is utilized to sense the peripheral environment information and the position of the follower car B. For example, please refer to FIG. 2. The follower-car sensing device 12 outputs a follower-car sensing information D_rs. The follower-car sensing information D_rs includes a follower-car positioning coordinate, a front-car width, and a first relative distance. The first relative distance indicates a relative distance sensing value between the follower car B and an object in front of the follower car B, wherein the position of the follower car B is defined as the initial position for the first relative distance. In normal conditions, the object in front of the follower car B is the front car A, and the first relative distance is the relative distance sensing value between the follower car B and the front car A. For instance, the follower-car information device 13 can be the on-board diagnostics (OBD) system of the follower car B itself, a data bus (such as a controller area network bus (CAN Bus), or an instrument system and so on. Therefore, the follower-car controlling device 10 of the present invention can retrieve a follower-car local information D_rv of the follower car B from the follower-car information device 13. The follower-car local information D_rv includes a follower-car acceleration/deceleration, a follower-car speed, a follower-car steering angle, and so on.

The operating principle of the front-car controlling device 20 is similar to the follower-car controlling device 10. In brief, the front-car controlling device 20 is disposed in the front car A and connected to a front car communication device 21, a front-car sensing device 22 and a front car information device 23 disposed in the front car A by a signal. The front car communication device 21 includes a front-car V2V communication module 210 or further includes a front-car mobile communication module 211. The front-car sensing device 22 outputs a front-car sensing information D_fs. The front-car sensing information D_fs includes a front-car positioning coordinate and a second relative distance. The second relative distance indicates the relative distance sensing value between the front car A and an object in back of the front car A, wherein the position of the front car A is defined as the initial position. In normal conditions of following the car, the object in back of the front car A is the follower car B, and the second relative distance is the relative distance sensing value between the front car A and the follower car B. The front-car controlling device 20 can retrieve a front-car local information D_fv of the front car A from the front car information device 23. The front-car local information D_fv includes a front car acceleration, a front car deceleration, a front-car speed and a front-car steering angle and so on.

In above descriptions, the follower-car sensing device 12 and the front-car sensing device 22 may respectively include a satellite positioning system, a three-dimensional light detection and ranging (3D LiDAR), a two-dimensional light detection and ranging (2D LiDAR), a camera, a real-time kinematic (RTK), and an inertial measurement unit (IMU), but are not limited thereto. Hence, the follower-car sensing device 12 generates the follower-car sensing information D_rs, and the front-car sensing device 22 generates the front-car sensing information D_fs.

When the follower-car V2V communication module 110 builds a connection with the front-car V2V communication module 210, the follower-car controlling device 10 may communicate with the front-car controlling device 20 by a bi-directional communication. Please refer to FIG. 2. The front-car controlling device 20 periodically transmits a front-car information package P_f to the follower-car controlling device 10, wherein the transmitting period of it may be, for example, 100 milliseconds. The front-car information package P_f is generated from the front-car sensing information D_fs and the front-car local information D_fv. For instance, the front-car information package P_f includes, but is not limited to, the front-car positioning coordinate, the front-car speed, the front-car steering angle, and the second relative distance. Accordingly, the follower-car controlling device 10 acquires the information of the front car A as a reference for subsequent decision-making.

The background host 30 may be a cloud server communicating with the follower-car controlling device 10 and the front-car controlling device 20. For example, when the follower-car mobile communication module 111 builds a connection (such as via Internet) with the background host 30, the follower-car controlling device 10 may communicate with the background host 30 by a bi-directional communication via the follower-car mobile communication module 111. Similarly, while the front-car mobile communication module 211 builds a connection (such as via Internet) with the background host 30, the front-car controlling device 20 may communicate with the background host 30 by a bi-directional communication via the front-car mobile communication module 211.

As mentioned above, in the embodiments of the present invention, the background host 30 communicates with the follower-car controlling device 10 and the front-car controlling device 20, and there is a connection between the follower-car controlling device 10 and the front-car controlling device 20. Consequently, there are multiple methods to transmit information performed in parallel in the present invention. That is, when the follower-car controlling device 10 and the front-car controlling device 20 communicate with each other, they respectively simultaneously transmit information to the background host 30. In the embodiments of the present invention, the follower-car controlling device 10 and the front-car controlling device 20 may utilize the V2V communication as the main communication method. When the V2V communication is disconnected, the follower-car controlling device 10 and the front-car controlling device 20 communicate with each other via the background host 30. That is, the background host 30 is utilized as a medium for transmitting information.

### 2. Estimating of a Car Interval Distance

Generally speaking, with reference to FIG. 1 and FIG. 3, the follower-car controlling device 10 controls the follower car B to follow the front car A according to a following condition 100. The following condition 100 of the follower-car controlling device 10 may be set as a predetermined comparison information of car-following speeds and car-following distances. The relation between the car-following speed and the car-following distance is a positive correlation. The faster the car-following speed is, the longer the car-following distance is. Vice versa, the slower the car-following speed is, the shorter the car-following distance is. The follower-car controlling device 10 compares an estimated car interval distance (that is, estimating the relative distance between the follower car B and the front car A, as described below) with the car-following distance of the following condition 100 according to the current car-following speed (that is, the car-following speed) with the car-following distance defined in the following condition 100 to appropriately regulate the follower-car throttle system 41 and the follower-car braking system 42 (or further regulates the follower-car direction system 43). In this way, when the follower car B drives at a certain speed, the estimated car interval distance corresponds to the car-following distance defined in the following condition 100. For example, when the estimated car interval distance is more than the car-following distance of the following condition 100, which represents that the distance between the follower car B and the front car A is too long, the follower-car controlling device 10 regulates the follower-car throttle system 41 to accelerate the follower car B. By this way, the difference between the estimated car interval distance and the car-following distance of the following condition 100 will be decreased.

When the car platoon is going, transmitting information between the follower-car controlling device 10 and the front-car controlling device 20 and calculating information by the follower-car controlling device 10 need to take some time since the front car A and the follower car B are driving. Therefore, in the embodiments of the present invention, to avoid the follower-car controlling device 10 performing the current following car decision according to the earlier information, the follower-car controlling device 10 further calculates the estimated car interval distance (D_{RF}), which indicates the relative distance between the follower car B and the front car A. The details are described below.

The follower-car controlling device 10 presets a time interval value Δt_seg, a tolerable error range ΔE, a first weight value W₁, a second weight value W₂, and a third weight value W₃ preset by the user. The relation between the car speed and the tolerable error range ΔE is a negative correlation. That is, the faster the car drives, the narrower the tolerable error range ΔE is, which can make sure the distance tolerance is less at the faster speed. The tolerable error range ΔE is calculated according to a reference distance value U (meter) and a percentage value V(%). The minimum of the tolerable error range ΔE is U−U×V %. The maximum of the tolerable error range ΔE is U+U×V %. The reference distance value U and the percentage value V are predetermined values.

As aforementioned descriptions, the follower-car controlling device 10 obtains the first relative distance (defined as D_x herein) from the follower-car sensing information D_rs. The first relative distance D_x indicates the relative distance sensing value between the follower car B and the front car A, wherein the position of the follower car B is defined as an initial position. The follower-car controlling device 10 obtains the second relative distance (defined as D_y herein) from the front-car information package P_f. The second relative distance D_y indicates the relative distance sensing value between the front car A and the follower car B, wherein the position of the front car A is defined as an initial position. The follower-car controlling device 10 calculates an estimated shift distance Dₚ. W₁, W₂, and W₃ respectively represent weight values less than 1 and W₁+W₂+W₃≤1. The time interval value Δt_seg represents an elapsed time or further includes a delay time that the front-car information package P_f is transmitted from the front-car controlling device 20 to the follower-car controlling device 10 and so on. For instance, Δt_seg may be preset as 100-200 milliseconds. The estimated shift distance Dₚ is represented as Dₚ=S·Δt_seg, wherein S is the car-following speed of the follower-car local information D_rv received by the follower-car controlling device 10. The follower-car controlling device 10 calculates the estimated car interval distance D_{RF} according to the first relative distance D_x, the second relative distance D_y, and the estimated shift distance Dₚ corresponding to the weight value W₁, W₂, W₃.

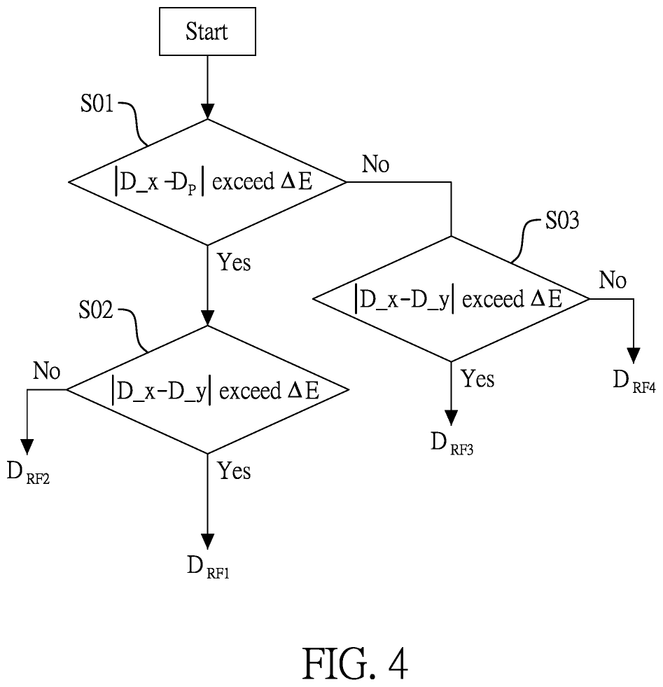

The below descriptions are according to the prerequisite that the communication between the follower-car controlling device 10 and the front-car controlling device 20 is normal, and the follower-car sensing device 12 operates normally. With reference to FIG. 4, firstly, the follower-car controlling device 10 determines whether the value of |D_x−Dₚ| exceeds the tolerable error range ΔE (step S01).

In step S01, when the follower-car controlling device 10 determines that the value of |D_x−Dₚ| exceeds the tolerable error range ΔE, this indicates that the difference between the first relative distance D_x and the estimated shift distance Dₚ is greater. Hence, the follower-car controlling device 10 further determines whether the value of |D_x−D_y| exceeds the tolerable error range ΔE (step S02). In step S02, when the follower-car controlling device 10 determines that the value of |D_x−D_y| exceeds the tolerable error range ΔE, which indicates the difference between the first relative distance D_x and the second relative distance D_y is greater. The estimated car interval distance D_{RF} calculated by the follower-car controlling device 10 is defined as a first estimated car interval distance D_{RF1}.In contrast, in step S02, when the follower-car controlling device 10 determines that the value of |D_x−D_y| does not exceed the tolerable error range ΔE, which indicates that the difference between the first relative distance D_x and the second relative distance D_y is low. The estimated car interval distance D_{RF} calculated by the follower-car controlling device 10 is defined as a second estimated car interval distance D_{RF2}.

In step S01, when the follower-car controlling device 10 determines that the value of |D_x−D_y| does not exceed the tolerable error range ΔE, this indicates that the difference between the first relative distance D_x and the estimated shift distance Dₚ is low. Therefore, the follower-car controlling device 10 further determines whether the value of |D_x−D_y| exceeds the tolerable error range ΔE(step S03). In step S03, when the follower-car controlling device 10 determines that the value of |D_x−D_y| exceeds the tolerable error range ΔE, the estimated car interval distance D_{RF} calculated by the follower-car controlling device 10 is defined as a third estimated car interval distance D_{RF3}. In contrast, in step S03, when the follower-car controlling device 10 determines that the value of |D_x−D_y| does not exceed the tolerable error range ΔE, the estimated car interval distance D_{RF} calculated by the follower-car controlling device 10 is defined as a fourth estimated car interval distance D_{RF4}.

For example, the first estimated car interval distance D_{RF1} may be expressed as below:

D_{RF1}=W₁×D_x+W₂×D_y+W₃×Dₚ, it can be seen that Dₓ, D_{y}, and Dₚ are adjusted according to the weights. If the user considers a presetting weight is that D_x is the priority, D_y is after that, and Dₚ is the last order, the proportion of the weights may be set as W₁>W₂>W₃. For instance, if W₁+W₂+W₃=1, in an embodiment, W₁ can be set as 0.5, W₂ can be set as 0.33, and W₃ can be set as 0.17. In other words, D_x occupies 50% of D_{RF1}, D_y occupies 33% of D_{RF1}, and Dₚ occupies 17% of D_{RF1}.

For instance, the second estimated car interval distance D_{RF2} may be expressed as below:

D_{RF2}=W₁×Da+W₂×Db+W₃×Dc, wherein W₃<W₁, and W₃<W₂. Consequently, when the follower-car controlling device 10 determines D_{RF}=D_{RF2}, the follower-car controlling device 10 determines that the closest two weight values are respectively as Da and Db, and another weight value is as Dc among D_x, D_y and Dₚ. The follower-car controlling device 10 adjusts the weight value W₁, W₂ of Da and Db to be higher, and adjusts the weight value W₃ of Dc to be lower. For instance, when the variation of D_x and D_y is less than the variation of D_x and Dₚ, and the variation of D_x and Dₚ is less than the variation of D_y and Dₚ, D_x and D_y are closest to each other and are respectively as Da and Db, and Dₚ is as Dc.

For instance, the third estimated car interval distance D_{RF3} may be expressed as below:

D_{RF3}=W₁×D_x+W₂×D_y+W₃×Dₚ, wherein W₂<W₁, and W₂<W₃. When the follower-car controlling device 10 determines D_{RF}=D_{RF3}, the follower-car controlling device 10 adjusts the weight value of the second relative distance D_y to be lower.

For instance, the fourth estimated car interval distance D_{RF4} may be expressed as below:

D_{RF4}=(W₁×D_x+W₂×D_y+W₃×Dₚ)/(W₁+W₂+W₃). When the follower-car controlling device 10 determines D_{RF}=D_{RF4}, the follower-car controlling device 10 averages the weight values for D_x, D_y and Dₚ.

### 3. Cut-In Decision Manner

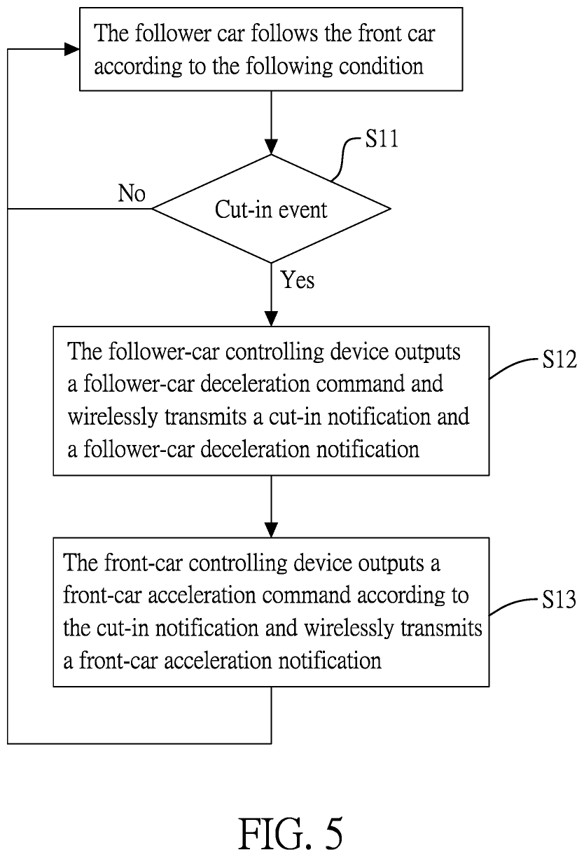

Referring to FIG. 1, there is a car interval between the follower car B and the front car A, which cannot avoid the car in another lane cutting into or crossing the car interval between the follower car B and the front car A from another lane to the lane. Therefore, referring to FIGS. 3, 5 and 6A, the decision manner implemented by the follower-car controlling device 10 determines whether a cut-in event occurs (step S11). The cut-in event represents that a car which is not the front car A and defined as a stranger car C in another lane (that is, the car cuts into the lane indicates that the car is in another lane rather than in the present lane) cuts into the car interval between the follower car B and the front car A.

For the cut-in event determined by the present invention, taking the follower-car controlling device 10 as an example, as mentioned above, the follower-car controlling device 10 obtains the first relative distance from the follower-car sensing information D_rs. The first relative distance indicates the relative distance sensing value between the follower car B and an object in front of the follower car B, wherein the position of the follower car B is defined as an initial position; besides, the follower-car controlling device 10 obtains the second relative distance from the front-car information package P_f, wherein the second relative distance indicates the relative distance sensing value between the front car A and an object in back of the front car A, wherein the position of the front car A is defined as an initial position.

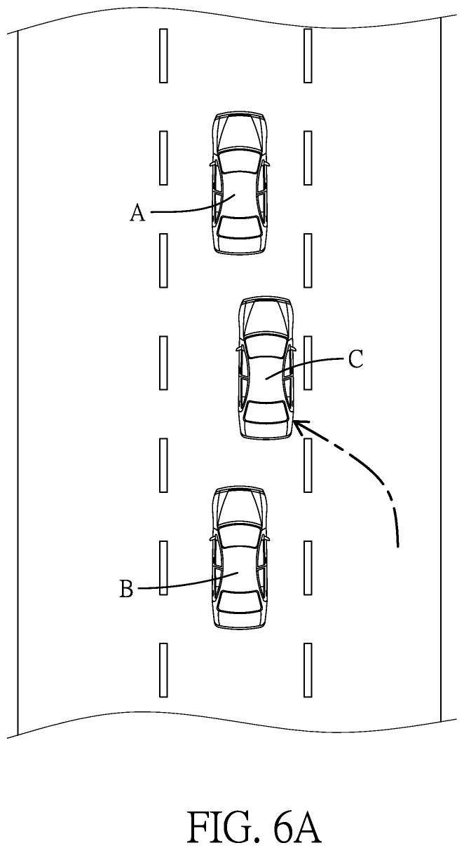

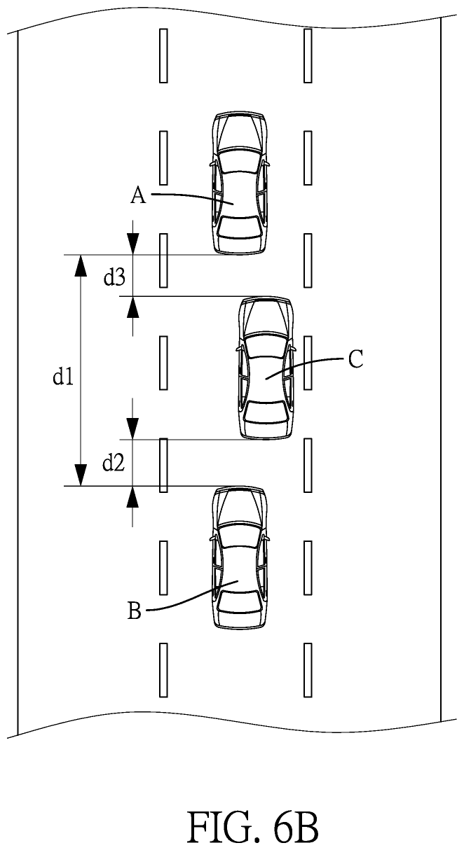

The follower-car controlling device 10 determines whether the variation of the first relative distance in a unit time is more than or equal to a first threshold, and determines whether the variation of the second relative distance in the unit time is more than or equal to a second threshold, wherein the first threshold may be the same as or different from the second threshold. For instance, in the normal situation for the follower car B following the front car A, the first relative distance and the second relative distance are stable. Hence, the variation of the first relative distance in the unit time is less than the first threshold, and the variation of the second relative distance in the unit time is less than the second threshold. In other words, in the normal situation for the follower car B following the front car A, the first relative distance and the second relative distance should be close to a distance dl as shown in FIG. 6B. It needs to be noted that, the preset value of the first threshold and the second threshold relates to the velocity of the follower car B and the front car A. That is, the faster the velocities of the follower car B and the front car A are, the less the first threshold and the second threshold are whereby the car has more response time at a faster velocity.

When the stranger car C in another lane cuts into the car interval between the follower car B and the front car A, the follower-car controlling device 10 detects the stranger car C in another lane to decelerate abruptly. In the meantime, the first relative distance suddenly becomes the relative distance sensing value between the follower car B and the stranger car C, as a distance d2 shown in FIG. 6B, which causes the first relative distance to abruptly become smaller (that is, changed from d1 to d2). Therefore, the variation of the first relative distance determined by the follower-car controlling device 10 in a unit time is more than or equal to the first threshold. Similarly, the second relative distance suddenly becomes the relative distance sensing value between the front car A and the stranger car C, as a distance d3 shown in FIG. 6B, which causes the second relative distance to abruptly become smaller (that is, changed from dl to d3). Therefore, the variation of the second relative distance determined by the follower-car controlling device 10 in a unit time is more than or equal to the second threshold.

When the follower-car controlling device 10 simultaneously determines that the variation of the first relative distance in a unit time is more than or equal to the first threshold, and determines the variation of the second relative distance in a unit time is more than or equal to the second threshold, the follower-car controlling device 10 determines that the cut-in event is generated. The determination of the cut-in event in the present invention correlates to the first relative distance sensed by the follower-car sensing device 12 and the second relative distance sensed by the front-car sensing device 22; therefore, the present invention estimates the relative distance of the follower car B and the front car A to double check so that the determination of the cut-in event is more accurate.

Referring to FIG. 3 to FIG. 7A, when the follower-car controlling device 10 detects the cut-in event, the follower-car controlling device 10 outputs a follower-car deceleration command S1 to the follower car B to control the follower car B to decelerate. For example, the follower-car deceleration command S1 is utilized to limit the opening angle of the throttle valve of the follower-car throttle system 41 and/or enhance the braking strength of the follower-car braking system 42 to decelerate the follower car B. In addition, the follower-car controlling device 10 wirelessly transmits a cut-in notification N1 and a follower-car deceleration notification N2 (step S12) via the follower-car communication device 11.

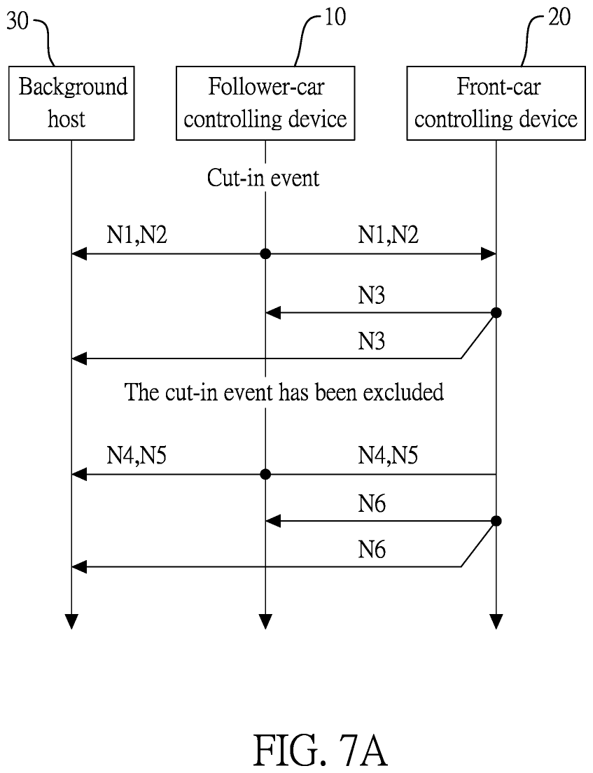

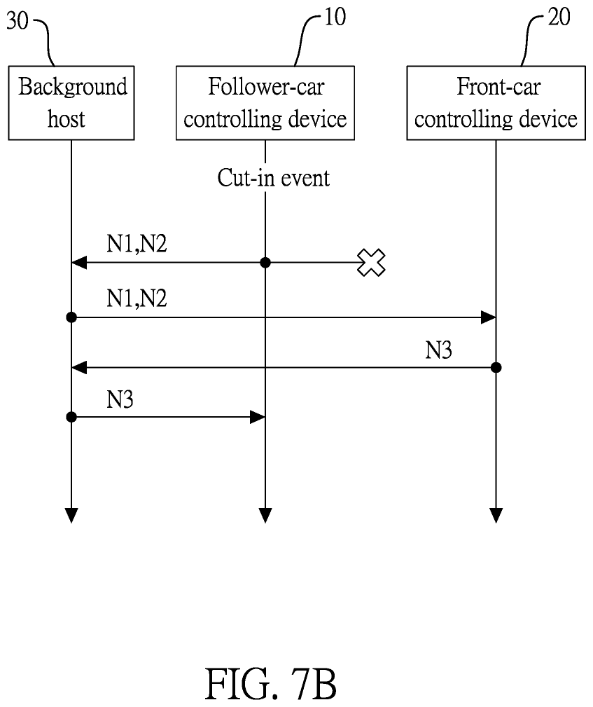

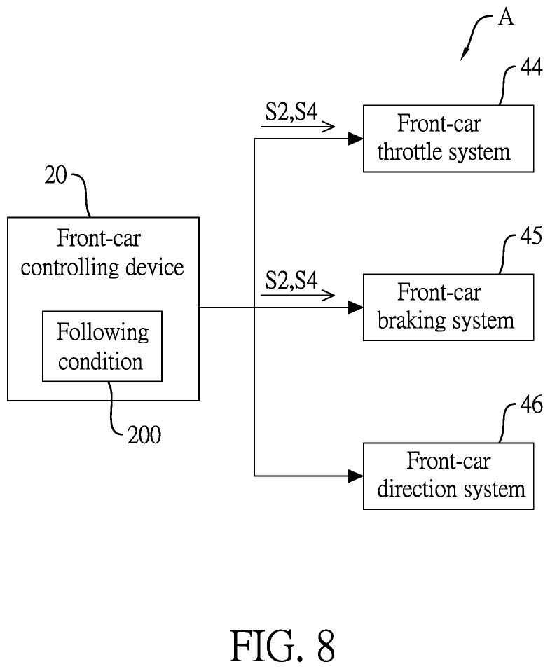

When the follower-car controlling device 10 builds a connection with the front-car controlling device 20, the front-car controlling device 20 receives the cut-in notification N1 and the follower-car deceleration notification N2 transmitted by the follower-car controlling device 10. Referring to FIG. 7A and FIG. 8, the front-car controlling device 20 outputs a front-car acceleration command S2 to the front car A to control the front car A to accelerate according to the cut-in notification N1. For example, the front-car acceleration command S2 is utilized to increase the opening angle of the throttle valve of the accelerator of the front-car throttle system 44 to accelerate the front car A, so that the front car A can maintain a safe distance from the car C. Besides, as shown in FIG. 7A, when the front-car controlling device 20 wirelessly transmits a front-car acceleration notification N3 to the follower-car controlling device 10, the follower-car controlling device 10 determines that the front car A is to accelerate (step S13) according to the received front-car acceleration notification N3.

Because the follower car B has decelerated and the front car A has accelerated, the car interval between the follower car B and the front car A has been extended. Consequently, the car C can drive between the follower car B and the front car A to sustain the car platoon in the present lane. In the meantime, the follower car B follows the stranger car C in the present lane behind the stranger car C and obeys the following condition 100.

Moreover, referring to FIG. 7A, when the follower-car controlling device 10 wirelessly transmits the cut-in notification N1 and the follower-car deceleration notification N2 to the front-car controlling device 20 via the follower-car communication device 11, the follower-car controlling device 10 also transmits the cut-in notification N1 and the follower-car deceleration notification N2 to the background host 30. When the front-car controlling device 20 wirelessly transmits the front-car acceleration notification N3 to the follower-car controlling device 10 via the front car communication device 21, the front-car controlling device 20 also transmits the front-car acceleration notification N3 to the background host 30. Therefore, the background host 30 can master the operating states of the front car A and the follower car B. Referring to FIG. 7B and FIG. 8, when the follower-car controlling device 10 is disconnected from the front-car controlling device 20, the background host 30 transmits the cut-in notification Ni and the follower-car deceleration notification N2 to the front-car controlling device 20. The front-car controlling device 20 outputs the front-car acceleration command S2 to the front car A to control the front car A to accelerate according to the cut-in notification N1 transmitted by the background host 30. Moreover, the front car communication device 21 wirelessly transmits the front-car acceleration notification N3 to the background host 30, and the background host 30 further transmits the front-car acceleration notification N3 to the follower-car controlling device 10.

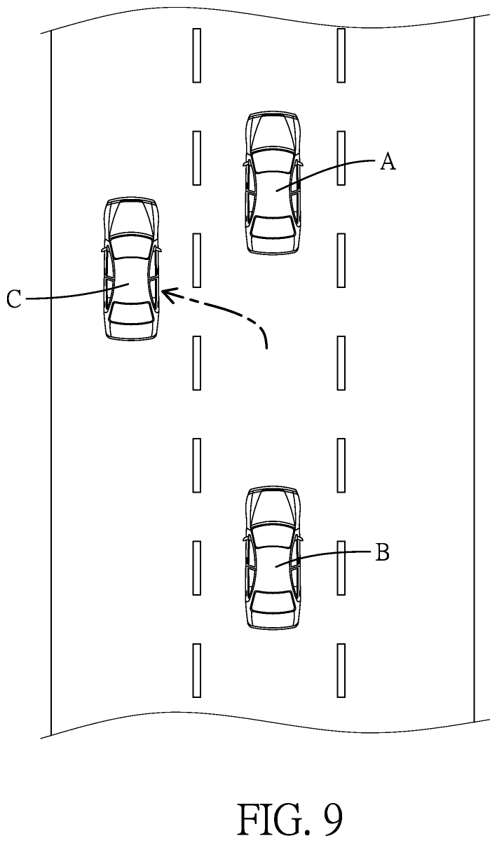

Please refer to FIG. 9, after the car C between the follower car B and the front car A drives away from the present lane, the follower-car controlling device 10 detects that the cut-in event has been excluded. At the time, referring to FIG. 3 and FIG. 7A, the follower-car controlling device 10 outputs a follower-car acceleration command S3 to the follower car B to control the follower car B to accelerate, and wirelessly transmits a cut-in-excluded notification N4 and a follower-car acceleration notification N5 to the front-car controlling device 20 and the background host 30. Referring to FIG. 7A and FIG. 8, the front-car controlling device 20 outputs a front-car deceleration command S4 to the front car A to control the front car A to decelerate, and wirelessly transmits a front-car deceleration notification N6 to the follower-car controlling device 10 and the background host 30 according to the cut-in-excluded notification N4. As mentioned above, when the follower-car controlling device 10 disconnects from the front-car controlling device 20, the background host 30 is utilized as a media for transmitting the cut-in-excluded notification N4, the follower-car acceleration notification N5 and the front car to decelerate notice N6.

Because the follower car B has accelerated and the front car A has decelerated, the car interval between the follower car B and the front car A has been decreased so that the follower-car controlling device 10 of the follower car B stably follows the front car A behind the front car A according to the following condition 100.

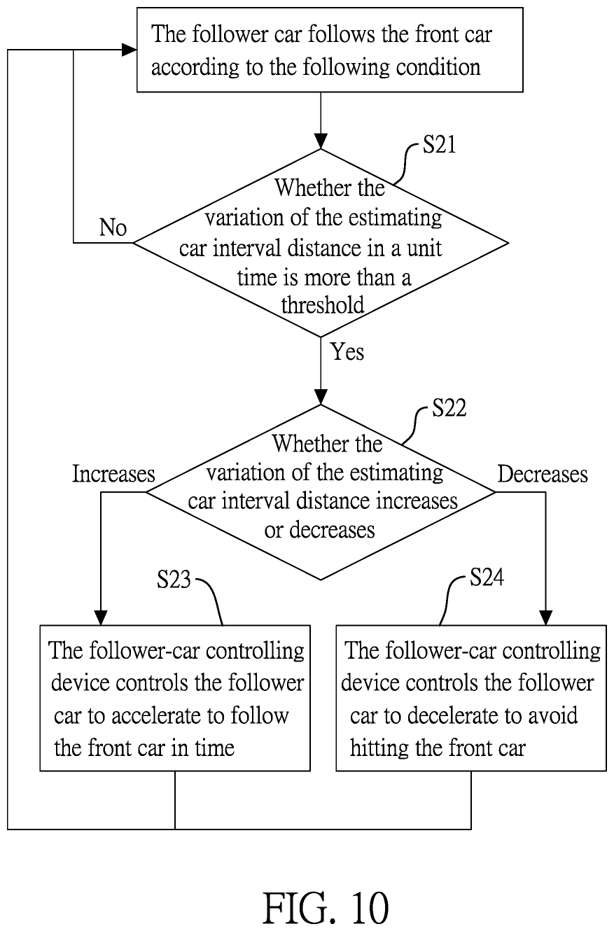

The aforementioned descriptions relate to the decision for the stranger car C cutting into the car platoon. On the other hand, the follower-car controlling device 10 controls the follower car B to accelerate or to decelerate according to the variation of the estimated car interval distance. Referring to FIG. 10, the follower-car controlling device 10 determines whether the variation of the estimated car interval distance in a unit time is more than a threshold (step S21); if not, the follower-car controlling device 10 obeys the following condition to follow the front car A behind the front car; if yes, the follower-car controlling device 10 further determines whether the variation of the estimated car interval distance increases or decreases (step S22). When the variation of the estimated car interval distance increases, the follower-car controlling device 10 controls the follower car B to accelerate so as to follow the front car A in time (step S23). When the variation of the estimated car interval distance decreases, the follower-car controlling device 10 controls the follower car B to decelerate so as to avoid hitting the front car A (step S24). In addition, if there is an accident, such as the follower-car controlling device 10 receiving an unexpected notice of the background host 30, the follower-car controlling device 10 controls the follower car B to decelerate or to stop.

### 4. Information Synchronization Mechanism

As mentioned above, the front-car controlling device 20 periodically transmits the front-car information package to the background host 30 and the follower-car controlling device 10. The background host 30 and the follower-car controlling device 10 of the present invention implement an information synchronization mechanism, which determines whether a plurality of the front-car information packages P_f received by the background host 30 and the follower-car controlling device 10 are continuous packages or have a delayed time to confirm the effectivity of the plurality of the front-car information packages P_f transmitted by the front-car controlling device 20.

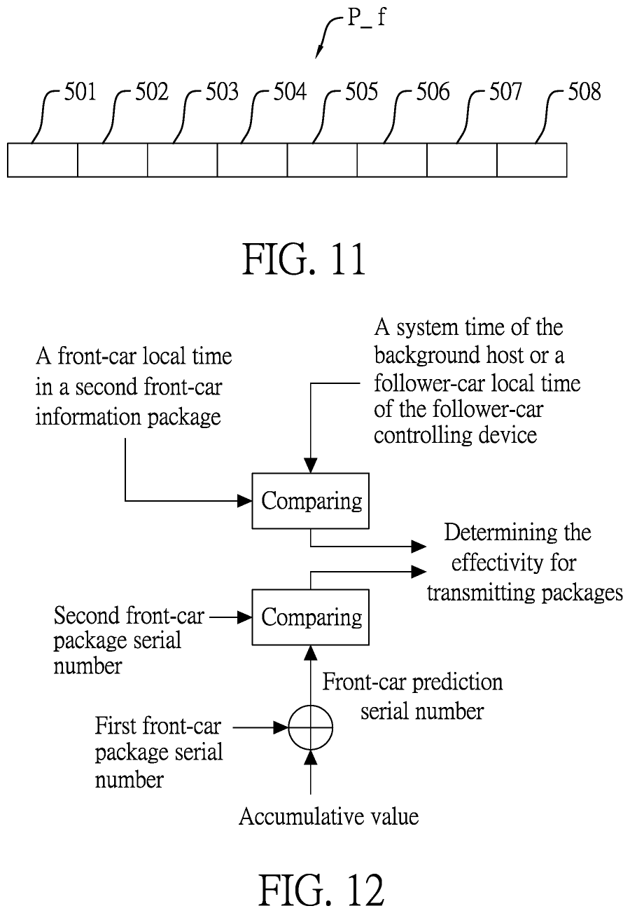

FIG. 11 discloses the data format of the front-car information package P_f, each of which may include, but not limited to, a start symbol 501, a package serial number 502, a local time 503, a positioning information 504, a driving information 505, a steering angle information 506, a navigation information 507, and an ending symbol 508. The local time 503 is generated by the time of the front-car controlling device 20. The package serial number 502 is used to distinguish the sequential order of the front-car information package P_f. For instance, in the embodiments of the present invention, when the front-car controlling device 20 outputs the front-car information package P_f each time, the package serial number 502 will be added as an accumulative value. The positioning information 504 may be a positioning information of the Global Positioning System, which includes a positioning time and a coordinate (including the longitude and latitude, etc.). The driving information 505 includes an acceleration information, a deceleration information, a front-car speed information, and a braking information. The steering angle information 506 may be such as a steering angle of the wheel. The navigation information 507 represents the navigation direction of the front car A, such as the pitch information, the yaw information and the roll information of the front car A.

Referring to FIG. 12, the steps of the information synchronization mechanism are describe as below.

For convenience to explain, two front-car information packages sequentially received by the front-car controlling device 20 are respectively defined as a first front-car information package and a second front-car information package. The front-car controlling device 20 retrieves the package serial number of the first front-car information package as a first front-car package serial number, the package serial number of the second front-car information package as a second front-car package serial number, and the local time 503 as a front-car local time.

The front-car controlling device 20 adds the accumulative value to the first front-car package serial number to form a front-car prediction serial number. The accumulative value will be, for example, “1”. According to the result of comparing the front-car prediction serial number and the second front-car package serial number, and a time difference with a system time of the background host 30 or a follower car local time of the follower-car controlling device 10 contrasted with the front car local time of the second front-car information package, the effectivity of the plurality of the front-car information package P_f transmitted by the front-car controlling device 20 is confirmed.

Whereby, when the result of comparing the front-car prediction serial number with the second front-car package serial number is not a continuous serial number, such as when the front-car prediction serial number is “100”, but the second front-car package serial number is “109”, the front-car controlling device 20 determines that there is another missed package between the first front-car information package and the second front-car information package. On the other hand, when the time difference between the follower car local time of the follower-car controlling device 10 and the front car local time of the second front-car information package exceed a threshold time, the front-car controlling device 20 determines that there is another delayed package between the first front-car information package and the second front-car information package. When there is another missed package or delayed package, the information synchronization mechanism determines that the effectivity of the package transmitted by the front-car controlling device 20 is lower. For instance, if the background host 30 determines that the effectivity for transmitting packages is lower, it is determined that the front-car controlling device 20 disconnects from the follower-car controlling device 10.

In summary, when the car in another lane cuts into the interval between the front car and the follower car in the present lane, the present invention controls the follower car to decelerate. For the front car, in allowable situations (such as there is no car in front of the front car), the present invention controls the front car to accelerate to moderately prolong the distance between the front car and the follower car to avoid the accident. When the car cuts in and drives away from the present lane, the front car is to decelerate and the follower car is to accelerate to sustain the driving stability of the car platoon. On the other hand, the present invention responds to the real relative distance between the front car and the follower car via the estimated car interval distance to provide the follower-car controlling device to accurately refer to the real relative distance between the follower car and the front car. The present invention further estimates the effectivity for transmitting packages via the information synchronization mechanism to ensure the efficiency for following car decision.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A vehicle-platooning driving decision system, applied to a car platoon including a follower car and a front car, and including:
a follower-car controlling device, disposed in the follower car to control the follower car to follow the front car, wherein when the follower-car controlling device detects a cut-in event, the follower-car controlling device outputs a follower-car deceleration command to the follower car to control the follower car to decelerate, and wirelessly transmits a cut-in notification and a follower-car deceleration notification;
a front-car controlling device, disposed in the front car, wherein when the follower-car controlling device communicates with the front-car controlling device, the front-car controlling device receives the cut-in notification and the follower-car deceleration notification transmitted by the follower-car controlling device, outputs a front-car acceleration command to the front car to control the front car to accelerate according to the cut-in notification, and wirelessly transmits a front-car acceleration notification to the follower-car controlling device;
when the follower-car controlling device detects that the cut-in event has been excluded, the follower-car controlling device outputs a follower-car acceleration command to the follower car to control the follower car to accelerate, and wirelessly transmits a cut-in-excluded notification and a follower-car acceleration notification to the front-car controlling device;
the front-car controlling device outputs a front-car deceleration command to the front car to control the front car to decelerate according to the cut-in-excluded notification, and wirelessly transmits a front-car deceleration notification to the follower-car controlling device.

2. The vehicle-platooning driving decision system as claimed in claim 1, further including a background host, respectively connecting to the follower-car controlling device and the front-car controlling device;
the follower-car controlling device transmitting the cut-in notification and the follower-car deceleration notification to the background host, wherein when the follower-car controlling device disconnects from the front-car controlling device, the background host transmits the cut-in notification and the follower-car deceleration notification to the front-car controlling device, the front-car controlling device outputs the front-car acceleration command to the front car according to the cut-in notification transmitted by the background host, and wirelessly transmits the front-car acceleration notification to the background host, and the background host transmits the front-car acceleration notification to the follower-car controlling device.

3. The vehicle-platooning driving decision system as claimed in claim 2, wherein the background host and the follower-car controlling device implement an information synchronization mechanism, including:
two front-car information packages sequentially received from the front-car controlling device being respectively a first front-car information package and a second front-car information package, and retrieving a first front-car package serial number of the first front-car information package, a second front-car package serial number of the second front-car information package, and a front car local time;
adding the first front-car package serial number with an accumulative value to form a front-car prediction serial number, and determining effectivity of the two front-car information packages transmitted by the front-car controlling device according to a result for comparing the front-car prediction serial number with the second front-car package serial number and according to a time difference with a system time of the background host and the front car local time of the second front-car information package.

4. The vehicle-platooning driving decision system as claimed in claim 1, wherein the follower-car controlling device connects to a follower-car communication device, a follower-car sensing device and a follower-car information device disposed in the follower car by a first signal;
the follower-car controlling device obtains a first relative distance from a follower-car sensing information received by the follower-car sensing device, and the first relative distance represents a relative distance sensing value between the follower car and an object in front of the follower car, wherein a position of the follower car is defined as an initial position;
the follower-car controlling device obtains a second relative distance from a front-car information package received by the follower-car communication device, and the second relative distance represents a relative distance sensing value between the front car and an object in back of the front car, wherein a position of the front car is defined as an initial position;
the follower-car controlling device determines whether a variation of the first relative distance in a unit time is more than or equal to a first threshold, and determines whether a variation of the second relative distance in the unit time is more than or equal to a second threshold;
when the variation of the first relative distance in the unit time is more than or equal to the first threshold, and the variation of the second relative distance in the unit time is more than or equal to the second threshold, the follower-car controlling device determines that the cut-in event has been generated.

5. The vehicle-platooning driving decision system as claimed in claim 2, wherein the follower-car controlling device connects to a follower-car communication device, a follower-car sensing device and a follower-car information device disposed in the follower car by a first signal;
the follower-car controlling device obtains a first relative distance from a follower-car sensing information received by the follower-car sensing device, and the first relative distance represents a relative distance sensing value between the follower car and an object in front of the follower car, wherein a position of the follower car is defined as an initial position;
the follower-car controlling device obtains a second relative distance from a front-car information package received by the follower-car communication device, and the second relative distance represents a relative distance sensing value between the front car and an object in back of the front car, wherein a position of the front car is defined as an initial position;
the follower-car controlling device determines whether a variation of the first relative distance in a unit time is more than or equal to a first threshold, and determines whether a variation of the second relative distance in the unit time is more than or equal to a second threshold;
when the variation of the first relative distance in the unit time is more than or equal to the first threshold, and the variation of the second relative distance in the unit time is more than or equal to the second threshold, the follower-car controlling device determines that the cut-in event has been generated.

6. The vehicle-platooning driving decision system as claimed in claim 3, wherein the follower-car controlling device connects to a follower-car communication device, a follower-car sensing device and a follower-car information device disposed in the follower car by a first signal;
the follower-car controlling device obtains a first relative distance from a follower-car sensing information received by the follower-car sensing device, and the first relative distance represents a relative distance sensing value between the follower car and an object in front of the follower car, wherein a position of the follower car is defined as an initial position;
the follower-car controlling device obtains a second relative distance from a front-car information package received by the follower-car communication device, and the second relative distance represents a relative distance sensing value between the front car and an object in back of the front car, wherein a position of the front car is defined as an initial position;
the follower-car controlling device determines whether a variation of the first relative distance in a unit time is more than or equal to a first threshold, and determines whether a variation of the second relative distance in the unit time is more than or equal to a second threshold;
when the variation of the first relative distance in the unit time is more than or equal to the first threshold, and the variation of the second relative distance in the unit time is more than or equal to the second threshold, the follower-car controlling device determines that the cut-in event has been generated.

7. The vehicle-platooning driving decision system as claimed in claim 1, wherein the follower-car controlling device connects to a follower-car communication device, a follower-car sensing device and a follower-car information device disposed in the follower car by a second signal;
the follower-car controlling device receives a follower-car sensing information from the follower-car sensing device, and obtains a first relative distance from the follower-car sensing information and the first relative distance represents a relative distance sensing value between the follower car and the front car, wherein a position of the follower car is defined as an initial position;
the follower-car controlling device receives a front-car information package from the follower-car communication device, and obtains a second relative distance from the front-car information package, and the second relative distance represents a relative distance sensing value between the front car and the follower car, wherein a position of the front car is defined as an initial position;
the follower-car controlling device receives a follower-car local information from the follower-car information device, obtains a car-following speed from the follower-car local information, and calculates an estimated shift distance according to the car-following speed and a time interval value;
the follower-car controlling device controls the follower car to follow the front car according to a following condition, and the following condition is built in a predetermined comparison information with a car-following speed and a car-following distance; the follower-car controlling device calculates an estimated car interval distance according to the first relative distance, the second relative distance and the estimated shift distance corresponding to a weight value, and compares the estimated car interval distance with the car-following distance of the following condition to regulate a follower-car throttle system and a follower-car braking system of the follower car.

8. The vehicle-platooning driving decision system as claimed in claim 2, wherein the follower-car controlling device connects to a follower-car communication device, a follower-car sensing device and a follower-car information device disposed in the follower car by a second signal;
the follower-car controlling device receives a follower-car sensing information from the follower-car sensing device, and obtains a first relative distance from the follower-car sensing information and the first relative distance representing a relative distance sensing value between the follower car and the front car, wherein a position of the follower car is defined as an initial position;
the follower-car controlling device receives a front-car information package from the follower-car communication device, and obtains a second relative distance from the front-car information package, and the second relative distance represents a relative distance sensing value between the front car and the follower car, wherein a position of the front car is defined as an initial position;
the follower-car controlling device receives a follower-car local information from the follower-car information device, obtains a car-following speed from the follower-car local information, and calculates an estimated shift distance according to the car-following speed and a time interval value;
the follower-car controlling device controls the follower car to follow the front car according to a following condition, and the following condition is built in a predetermined comparison information with a car-following speed and a car-following distance; the follower-car controlling device calculates an estimated car interval distance according to the first relative distance, the second relative distance and the estimated shift distance corresponding to a weight value, and compares the estimated car interval distance with the car-following distance of the following condition to regulate a follower-car throttle system and a follower-car braking system of the follower car.

9. The vehicle-platooning driving decision system as claimed in claim 3, wherein the follower-car controlling device connects to a follower-car communication device, a follower-car sensing device and a follower-car information device disposed in the follower car by a second signal;
the follower-car controlling device receives a follower-car sensing information from the follower-car sensing device, and obtains a first relative distance from the follower-car sensing information and the first relative distance represents a relative distance sensing value between the follower car and the front car, wherein a position of the follower car is defined as an initial position;
the follower-car controlling device receives a front-car information package from the follower-car communication device, and obtains a second relative distance from the front-car information package, and the second relative distance represents a relative distance sensing value between the front car and the follower car, wherein a position of the front car is defined as an initial position;
the follower-car controlling device receives a follower-car local information from the follower-car information device, obtains a car-following speed from the follower-car local information, and calculates an estimated shift distance according to the car-following speed and a time interval value;
the follower-car controlling device controls the follower car to follow the front car according to a following condition, and the following condition is built in a predetermined comparison information with a car-following speed and a car-following distance; the follower-car controlling device calculates an estimated car interval distance according to the first relative distance, the second relative distance and the estimated shift distance corresponding to a weight value, and compares the estimated car interval distance with the car-following distance of the following condition to regulate a follower-car throttle system and a follower-car braking system of the follower car.

10. A vehicle-platooning driving decision method including:
controlling a follower car to follow a front car via a follower-car controlling device according to a following condition;
detecting whether a cut-in event is generated by the follower-car controlling device, if yes, the follower-car controlling device outputting a follower-car deceleration command to the follower car to control the follower car to decelerate, and wirelessly transmitting a cut-in notification and a follower-car deceleration notification;
wherein when the follower-car controlling device builds a connection with a front-car controlling device disposed in the front car, the front-car controlling device receives the cut-in notification and the follower-car deceleration notification, and outputs a front-car acceleration command to the front car to control the front car to accelerate according to the cut-in notification, and wirelessly transmits a front-car acceleration notification to the follower-car controlling device;
detecting whether the cut-in event is excluded by the follower-car controlling device, if yes, the follower-car controlling device outputting a follower-car acceleration command to the follower car to control the follower car to accelerate, and wirelessly transmitting a cut-in-excluded notification and a follower-car acceleration notification to the front-car controlling device;
wherein when the follower-car controlling device builds a connection with the front-car controlling device, the front-car controlling device outputs a front-car deceleration command to the front car to control the front car to decelerate according to the cut-in-excluded notification, and wirelessly transmits a front-car deceleration notification to the follower-car controlling device.

11. The vehicle-platooning driving decision method as claimed in claim 10, further including:
the follower-car controlling device transmitting the cut-in notification and the follower-car deceleration notification to a background host;
when the follower-car controlling device disconnects from the front-car controlling device, transmitting the cut-in notification and the follower-car deceleration notification by the background host to the front-car controlling device;
the front-car controlling device outputting the front-car acceleration command to the front car, and wirelessly transmitting the front-car acceleration notification to the background host according to the cut-in notification transmitted from the background host;
the background host transmitting the front-car acceleration notification to the follower-car controlling device.

12. The vehicle-platooning driving decision method as claimed in claim 11, further including an information synchronization mechanism, the information synchronization mechanism including:
sequentially receiving two front-car information packages by the background host and the follower-car controlling device from the front-car controlling device, and the two front-car information packages being respectively a first front-car information package and a second front-car information package, and retrieving a first front-car package serial number of the first front-car information package, a second front-car package serial number of the second front-car information package, and a front car local time;
adding the first front-car package serial number with an accumulative value by the background host and the follower-car controlling device to form a front-car prediction serial number, according to a result comparing the front-car prediction serial number with the second front-car package serial number, and comparing a time difference with a system time of the background host and the front car local time of the second front-car information package to determine effectivity of the two front-car information packages transmitted by the front-car controlling device.

13. The vehicle-platooning driving decision method as claimed in claim 10, wherein the step determining the cut-in event by the follower-car controlling device includes:
the follower-car controlling device obtaining a first relative distance by a follower car sensing information received from a follower-car sensing device, and the first relative distance representing a relative distance sensing value between the follower car and an object in front of the follower car, wherein a position of the follower car is defined as an initial position;
the follower-car controlling device receiving a front-car information package from a follower-car communication device, and obtaining a second relative distance from the front-car information package, and the second relative distance representing a relative distance sensing value between the front car and an object in back of the front car, wherein a position of the front car is defined as an initial position;
the follower-car controlling device determining whether a variation of the first relative distance in a unit time is more than or equal to a first threshold, and determining whether a variation of the second relative distance in the unit time is more than or equal to a second threshold;
wherein when the variation of the first relative distance in the unit time is more than or equal to the first threshold, and the variation of the second relative distance in the unit time is more than or equal to the second threshold, the follower-car controlling device determines that the cut-in event has been generated.

14. The vehicle-platooning driving decision method as claimed in claim 11, wherein the step determining the cut-in event by the follower-car controlling device includes:
the follower-car controlling device obtaining a first relative distance by a follower car sensing information received from a follower-car sensing device, and the first relative distance representing a relative distance sensing value between the follower car and an object in front of the follower car, wherein a position of the follower car is defined as an initial position;
the follower-car controlling device receiving a front-car information package from a follower-car communication device, and obtaining a second relative distance from the front-car information package, and the second relative distance representing a relative distance sensing value between the front car and an object in back of the front car, wherein a position of the front car is defined as an initial position;
the follower-car controlling device determining whether a variation of the first relative distance in a unit time is more than or equal to a first threshold, and determining whether a variation of the second relative distance in the unit time is more than or equal to a second threshold;
wherein when the variation of the first relative distance in the unit time is more than or equal to the first threshold, and the variation of the second relative distance in the unit time is more than or equal to the second threshold, the follower-car controlling device determines that the cut-in event has been generated.

15. The vehicle-platooning driving decision method as claimed in claim 12, wherein the step determining the cut-in event by the follower-car controlling device includes:
the follower-car controlling device obtaining a first relative distance by a follower car sensing information received from a follower-car sensing device, and the first relative distance representing a relative distance sensing value between the follower car and an object in front of the follower car, wherein a position of the follower car is defined as an initial position;
the follower-car controlling device receiving a front-car information package from a follower-car communication device, and obtaining a second relative distance from the front-car information package, and the second relative distance representing a relative distance sensing value between the front car and an object in back of the front car, wherein a position of the front car is defined as an initial position;
the follower-car controlling device determining whether a variation of the first relative distance in a unit time is more than or equal to a first threshold, and determining whether a variation of the second relative distance in the unit time is more than or equal to a second threshold;
wherein when the variation of the first relative distance in the unit time is more than or equal to the first threshold, and the variation of the second relative distance in the unit time is more than or equal to the second threshold, the follower-car controlling device determines that the cut-in event has been generated.

16. The vehicle-platooning driving decision method as claimed in claim 10, wherein the follower-car controlling device receives a follower-car sensing information from a follower-car sensing device, and obtains a first relative distance from the follower-car sensing information and the first relative distance represents a relative distance sensing value between the follower car and the front car, wherein a position of the follower car is defined as an initial position;
the follower-car controlling device receives a front-car information package from a follower-car communication device, and obtains a second relative distance from the front-car information package, and the second relative distance representing a relative distance sensing value between the front car and the follower car, wherein a position of the front car is defined as an initial position;
the follower-car controlling device receives a follower-car local information from the follower-car information device, obtains a car-following speed from the follower-car local information, and calculates an estimated shift distance according to the car-following speed and a time interval value;
the follower-car controlling device controls the follower car to follow the front car according to a following condition, and the following condition is built in a predetermined comparison information with a car-following speed and a car-following distance; the follower-car controlling device calculates an estimated car interval distance according to the first relative distance, the second relative distance and the estimated shift distance corresponding to a weight value, and compares the estimated car interval distance with the car-following distance of the following condition to regulate a follower-car throttle system and a follower-car braking system of the follower car.

17. The vehicle-platooning driving decision method as claimed in claim 11, wherein the follower-car controlling device receives a follower-car sensing information from a follower-car sensing device, and obtains a first relative distance from the follower-car sensing information and the first relative distance represents a relative distance sensing value between the follower car and the front car, wherein a position of the follower car is defined as an initial position;
the follower-car controlling device receives a front-car information package from the follower-car communication device, and obtains a second relative distance from the front-car information package, and the second relative distance represents a relative distance sensing value between the front car and the follower car, wherein a position of the front car is defined as an initial position;
the follower-car controlling device receives a follower-car local information from the follower-car information device, obtains a car-following speed from the follower-car local information, and calculates an estimated shift distance according to the car-following speed and a time interval value;
the follower-car controlling device controls the follower car to follow the front car according to a following condition, and the following condition is built in a predetermined comparison information with a car-following speed and a car-following distance; the follower-car controlling device calculates an estimated car interval distance according to the first relative distance, the second relative distance and the estimated shift distance corresponding to a weight value, and compares the estimated car interval distance with the car-following distance of the following condition to regulate a follower-car throttle system and a follower-car braking system of the follower car.

18. The vehicle-platooning driving decision method as claimed in claim 12, wherein the follower-car controlling device receives a follower-car sensing information from a follower-car sensing device, and obtains a first relative distance from the follower-car sensing information and the first relative distance represents a relative distance sensing value between the follower car and the front car, wherein a position of the follower car is defined as an initial position;
the follower-car controlling device receives a front-car information package from a follower-car communication device, and obtains a second relative distance from the front-car information package, and the second relative distance represents a relative distance sensing value between the front car and the follower car, wherein a position of the front car is defined as an initial position;
the follower-car controlling device receives a follower-car local information from the follower-car information device, obtains a car-following speed from the follower-car local information, and calculates an estimated shift distance according to the car-following speed and a time interval value;
the follower-car controlling device controls the follower car to follow the front car according to a following condition, and the following condition is built in a predetermined comparison information with a car-following speed and a car-following distance; the follower-car controlling device calculates an estimated car interval distance according to the first relative distance, the second relative distance and the estimated shift distance corresponding to a weight value, and compares the estimated car interval distance with the car-following distance of the following condition to regulate a follower-car throttle system and a follower-car braking system of the follower car.
